(19) United States
(12) Patent Application Publication
(10) Pub. No.: US 2014/0380164 A1
(43) Pub. Date: Dec. 25, 2014

(54) SYSTEMS AND METHODS FOR DISPLAYING WEBSITE CONTENT

(71) Applicant: THINKTANK HOLDINGS LLC, Jackson, WY (US)

(72) Inventors: Robb Brock, Aliso Viejo, CA (US); Scott A. Blum, Jackson, WY (US)

(21) Appl. No.: 14/311,620

(22) Filed: Jun. 23, 2014

Related U.S. Application Data
(60) Provisional application No. 61/838,617, filed on Jun. 24, 2013.

(51) Int. Cl. G06F 3/0484; G06F 3/0482

(52) U.S. Cl. CPC G06F 3/0484; G06F 3/0482
USPC 715/719

(57) ABSTRACT

A machine-executable method for displaying webpage media content comprises a network device receiving an input from a computing system. The network device verifies whether a user associated with the computing system is a logged-in member. If the user is a logged-in member, display or playback of the media content immediately begins on a display device or a webpage display application of the computing system, without receiving any further input from the computing system.

### CROSS-REFERENCE TO RELATED APPLICATION

This application claims priority to provisional application Ser. No. 61/838,617, filed on Jun. 24, 2013, the entire contents of which are hereby incorporated by reference.

### TECHNICAL FIELD

The present embodiments relate to displaying website content.

### BACKGROUND

Currently, when a user navigates to a webpage over the Internet, he or she must click through one or more links and/or buttons in order to execute playback of video content available through that webpage, or to begin display of still images. This process can be time consuming and confusing. It would be desirable to eliminate the need to take unnecessary action(s) when navigating to a webpage in order to execute playback of video content, or to begin display of still images.

### SUMMARY

The various embodiments of the present invention have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the realization that, currently, when a user navigates to a webpage over the Internet, he or she must click through one or more links and/or buttons in order to execute playback of video content available through that webpage, or to begin display of still images. This process can be time consuming and confusing.

In recognition of the foregoing problem, in a first aspect certain of the present embodiments comprise a machine-executable method for displaying webpage media content. The method comprises a network device receiving an input from a computing system. The method further comprises the network device verifying whether a user associated with the computing system is a logged-in member. The method further comprises, if the user is a logged-in member, then immediately beginning display or playback of the media content on a display device or a webpage display application of the computing system, without receiving any further input from the computing system.

In an embodiment of the first aspect, the media content fills a full viewable area of the display device or the webpage display application without any user interface (UI) elements, ads, overlay dialogs, or blank space.

In another embodiment of the first aspect, if the user is not a logged-in member, then the method further comprises beginning playback of a promotional video.

In another embodiment of the first aspect, the method further comprises displaying a login screen after playback of the promotional video.

In another embodiment of the first aspect, the login screen includes a link that enables the user to become a member.

In another embodiment of the first aspect, the media content comprises a video or at least one still image.

In another embodiment of the first aspect, the network device is a server.

In another embodiment of the first aspect, the method further comprises receiving an input from an input device of the computing system and displaying at least one of a pointer and a scrolling arrow on the display device.

In another embodiment of the first aspect, the method further comprises receiving an input from an input device of the computing system and displaying a menu on the display device.

In another embodiment of the first aspect, the menu includes at least one of a send command for sending one or more images to other users, an upload command for uploading images to the network device, and a download command for downloading images from the network device.

Also in recognition of the foregoing problem, in a second aspect certain of the present embodiments comprise a system for displaying webpage media content. The system comprises a computing system including a display device or a webpage display application, and a network device. The network device is configured to receive an input from the computing system, verify whether a user associated with the computing system is a logged-in member, and if the user is a logged-in member, then immediately begin display or playback of the media content on the display device or the webpage display application of the computing system, without receiving any further input from the computing system.

In an embodiment of the second aspect, the media content fills a full viewable area of the display device or the webpage display application without any user interface (UI) elements, ads, overlay dialogs, or blank space.

In another embodiment of the second aspect, if the user is not a logged-in member, then the network device is configured to begin playback of a promotional video.

In another embodiment of the second aspect, the network device is configured to display a login screen after playback of the promotional video.

In another embodiment of the second aspect, the login screen includes a link that enables the user to become a member.

In another embodiment of the second aspect, the media content comprises a video or at least one still image.

In another embodiment of the second aspect, the network device is a server.

In another embodiment of the second aspect, the network device is configured to receive an input from an input device of the computing system and display at least one of a pointer and a scrolling arrow on the display device.

In another embodiment of the second aspect, the network device is configured to receive an input from an input device of the computing system and display a menu on the display device.

In another embodiment of the second aspect, the menu includes at least one of a send command for sending one or more images to other users, an upload command for uploading images to the network device, and a download command for downloading images from the network device.

### BRIEF DESCRIPTION OF THE DRAWINGS

The various embodiments of the present systems and methods now will be discussed in detail with an emphasis on highlighting the advantageous features. These embodiments depict the novel and non-obvious systems and methods shown in the accompanying drawings, which are for illustrative purposes only. These drawings include the following figures, in which like numerals indicate like parts:

FIG. 1A is a functional block diagram of a system according to the present embodiments;

FIG. 1B is a functional block diagram of a computing system configured for use with the present systems and methods;

FIG. 1C is a functional block diagram of a video playback module configured for use with the present systems and methods;

FIG. 2 is a flowchart illustrating one embodiment of the present methods for displaying video content;

FIGS. 3-7 are screenshots illustrating playback of video content according to the present embodiments;

FIGS. 8-10 are screenshots illustrating a graphical user interface (GUI) for displaying webpage content; and

FIG. 11 is a flowchart illustrating one embodiment of the present methods for displaying webpage content.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

The embodiments of the present systems and methods are described below with reference to the figures. These figures, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unitary piece.

As a preliminary note, any of the embodiments described with reference to the figures may be implemented using software, firmware, hardware (e.g., fixed logic circuitry), manual processing, or a combination of these implementations. The terms “logic,” “module,” “component,” “system” and “functionality,” as used herein, generally represent software, firmware, hardware, or a combination of these elements. For instance, in the case of a software implementation, the terms “logic,” “module,” “component,” “system,” and “functionality” represent program code that performs specified tasks when executed on a processing device or devices (e.g., CPU or CPUs). The program code can be stored in one or more computer readable memory devices.

More generally, the illustrated separation of logic, modules, components, systems, and functionality into distinct units may reflect an actual physical grouping and allocation of software, firmware, and/or hardware, or can correspond to a conceptual allocation of different tasks performed by a single software program, firmware program, and/or hardware unit. The illustrated logic, modules, components, systems, and functionality may be located at a single site (e.g., as implemented by a processing device), or may be distributed over a plurality of locations.

The term “machine-readable media” and the like refers to any kind of medium for retaining information in any form, including various kinds of storage devices (magnetic, optical, static, etc.). Machine-readable media also encompasses transitory forms for representing information, including various hardwired and/or wireless links for transmitting the information from one point to another.

The embodiments disclosed herein, may be implemented as a computer process (method), a computing system, or as an article of manufacture, such as a computer program product or computer-readable media. The computer program product may be computer storage media, readable by a computer device, and encoding a computer program of instructions for executing a computer process. The computer program product may also be a propagated signal on a carrier, readable by a computing system, and encoding a computer program of instructions for executing a computer process.

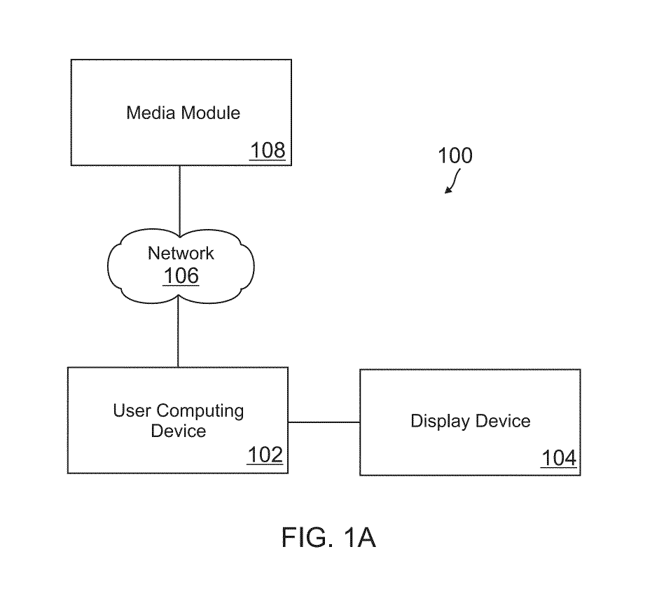

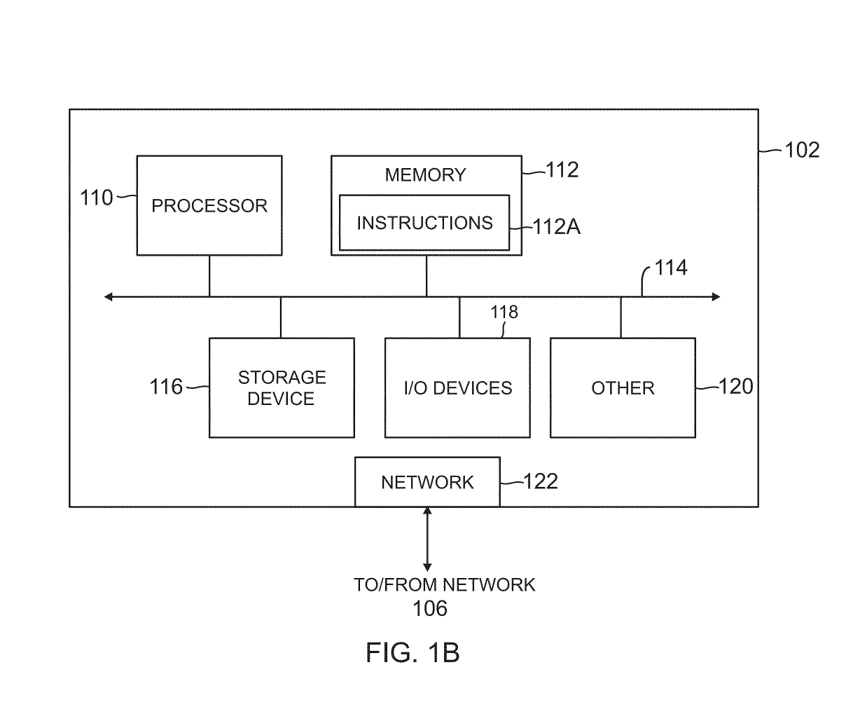

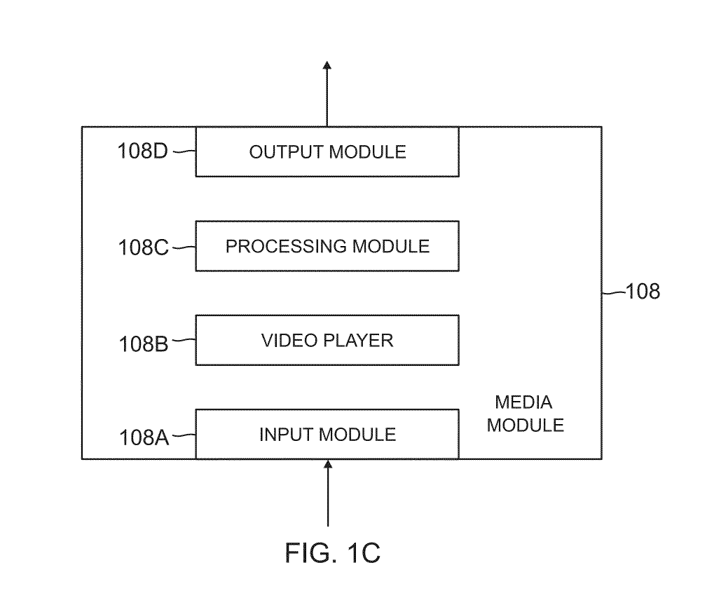

FIG. 1A is a block diagram of a system 100 including a user computing device 102, also referred to as computing system 102, interfacing with a network 106. The network 106 includes a plurality of interconnected devices, such as switches, routers, servers, other computing devices, etc. for facilitating electronic communication. The user computing device 102 interfaces with a display device 104, such as an LCD or LED monitor. While the display device 104 is illustrated as a separate entity in FIG. 1A, in certain embodiments it may be considered to be a part of the user computing device 102. FIG. 1A further illustrates a media module 108 (may also be referred to interchangeably as video module 108), which may be executed by a computing device (not shown) in the network 106 to provide playback of video content to a user of the user computing device 102, as further described below. The media module 108 may include, for example, one or more video or image files (not shown) configured to be accessed by a user for playback through the network 106.

FIG. 1B is a block diagram of the internal functional architecture of a typical computing system 102. The computing system 102 includes one or more processors 110, also known as a central processing unit (CPU). The processor 110 executes computer-executable process steps and interfaces with a computer bus 114. The computer bus 114 may be, for example, a system bus, a Peripheral Component Interconnect (PCI) bus (or PCI Express bus), a HyperTransport or industry standard architecture (ISA) bus, a SCSI bus, a universal serial bus (USB), or an Institute of Electrical and Electronics Engineers (IEEE) standard 1394 bus (sometimes referred to as “Firewire”). A network interface 122 facilitates the ability of the computing system 102 to interface with a network. The computing system 102 also includes one or more I/O devices 118 and other devices and interfaces 120, which may include a keyboard, a keyboard interface, a pointing device, a pointing device interface, a display device interface, etc.

The computing system 102 further includes a storage device 116, which may be for example a hard disk, a CD-ROM, or any other device. Storage 116 stores operating system program files, application program files, and other files. Some of these files are stored on storage 116 using an installation program. For example, the processor 110 may execute computer-executable process steps of an installation program so that the processor 110 can properly execute the application program.

Memory 112 also interfaces to the computer bus 114 to provide the processor 110 with access to memory storage. Memory 112 may include random access main memory (RAM) and read only memory (ROM). When executing stored computer-executable instructions 112A from storage 116, the processor 110 stores and executes the instructions 112A out of RAM. The instructions 112A may comprise, for example, the media module 108. ROM stores invariant instruction sequences, such as start-up instruction sequences or basic input/output operating system (BIOS) sequences for operation of a keyboard (not shown).

FIG. 1C is a block diagram of one embodiment of the media module 108 illustrated in FIG. 1A. The media module 108 comprises an input module 108A for receiving input from the network 106, which input may originate at the computing system 102. The media module 108 further comprises a video player 108B and a processing module 108C. The processing module 108C receives user input from the input module 108A and displays the video content directly to the user. The media module 108 further comprises an output module 108D for sending output to the network 106, which output may be forwarded to the computing system 102. The output may comprise, for example, video content for viewing on the display 104 associated with the computing system 102.

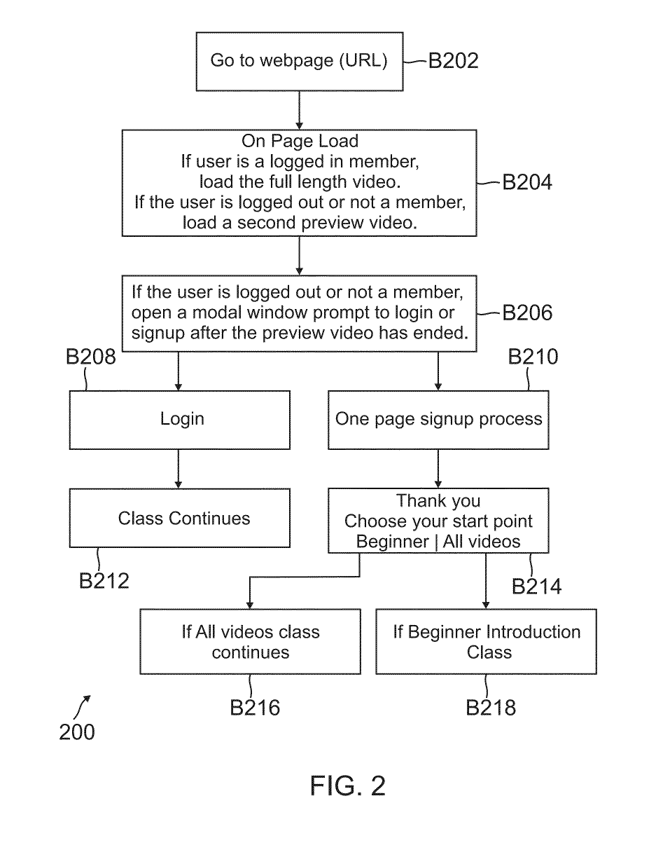

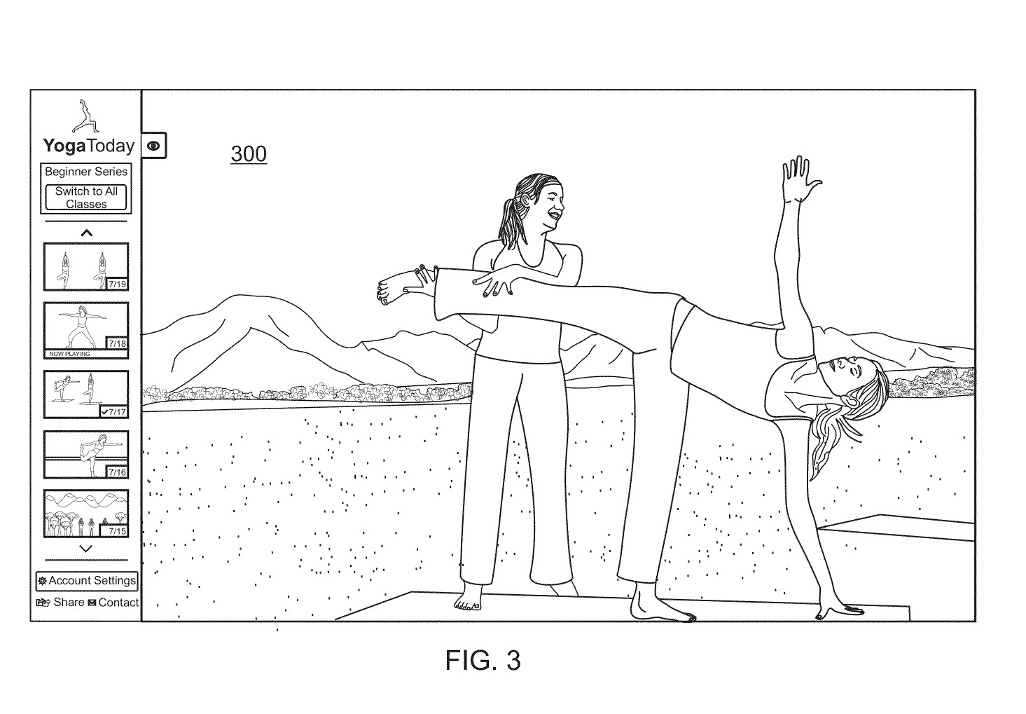

FIG. 2 is a flowchart illustrating one embodiment of a method 200 for displaying video content on a webpage. The process begins at box B202, when a user navigates to an Internet webpage that is configured to stream video content to the user's computing system. At box B204, if the user is a logged-in member, or registered user, a video 300 is immediately loaded and playback begins, as shown in FIG. 3. For example, the website may include a featured video that changes daily, weekly, etc. As soon as the user lands on the website, playback of the featured video 300 begins. There is no need for the user to perform any action to begin playback, other than navigating to the webpage. The present embodiments thus save time and effort for the user. The video also preferably fills the entire viewable area of the display device or webpage display application, without any user interface (UI) elements, ads, overlay dialogs, or blank space. However, if the user makes an input, such as by touching the screen, moving, or clicking his or her mouse, a user interface may appear.

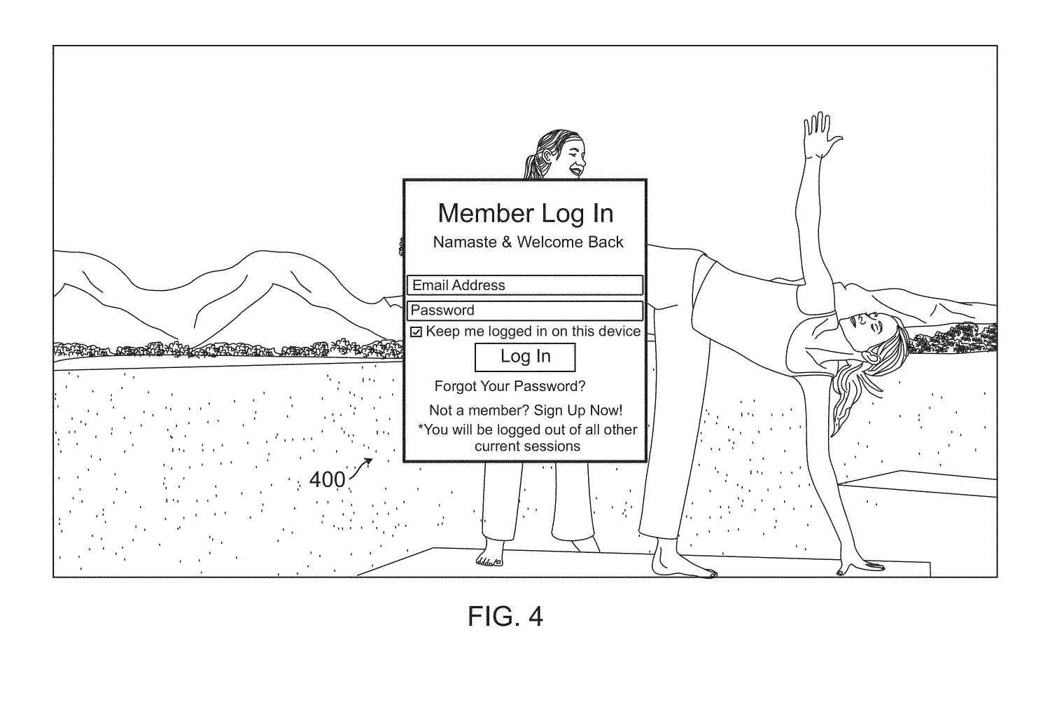

If however, the user is a member, but is not logged in, or the user is not a member, then the user is shown a promotional video, followed by a login screen 400, as shown in boxes B204 and B206 and illustrated in FIG. 4. However, if the user is a logged in member, (box B208), a video is immediately loaded and playback begins (box B212).

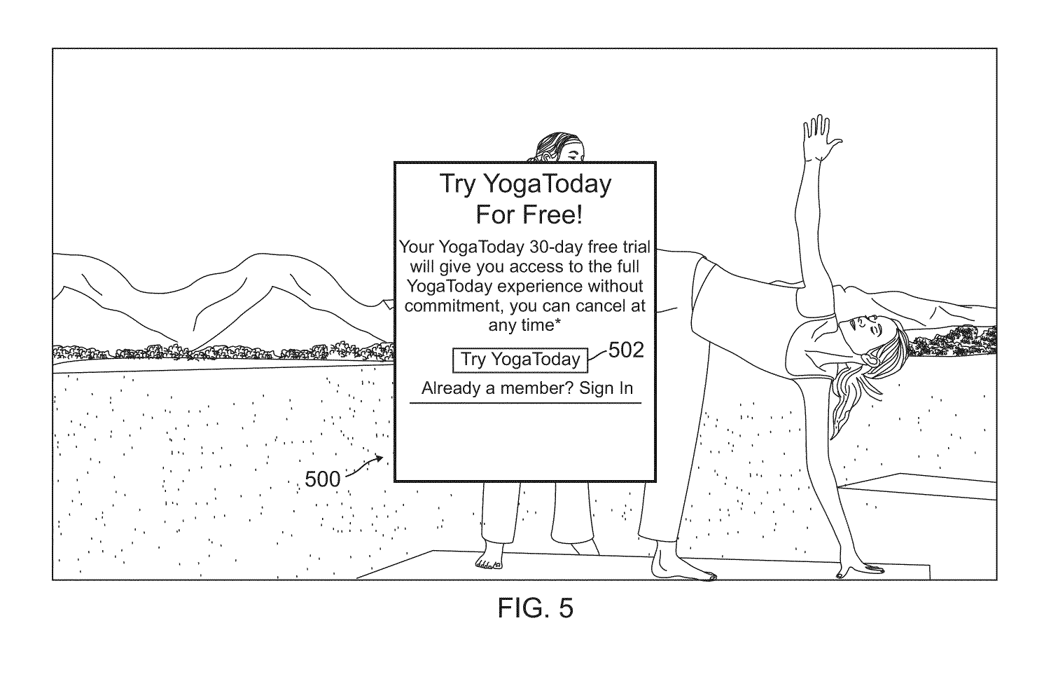

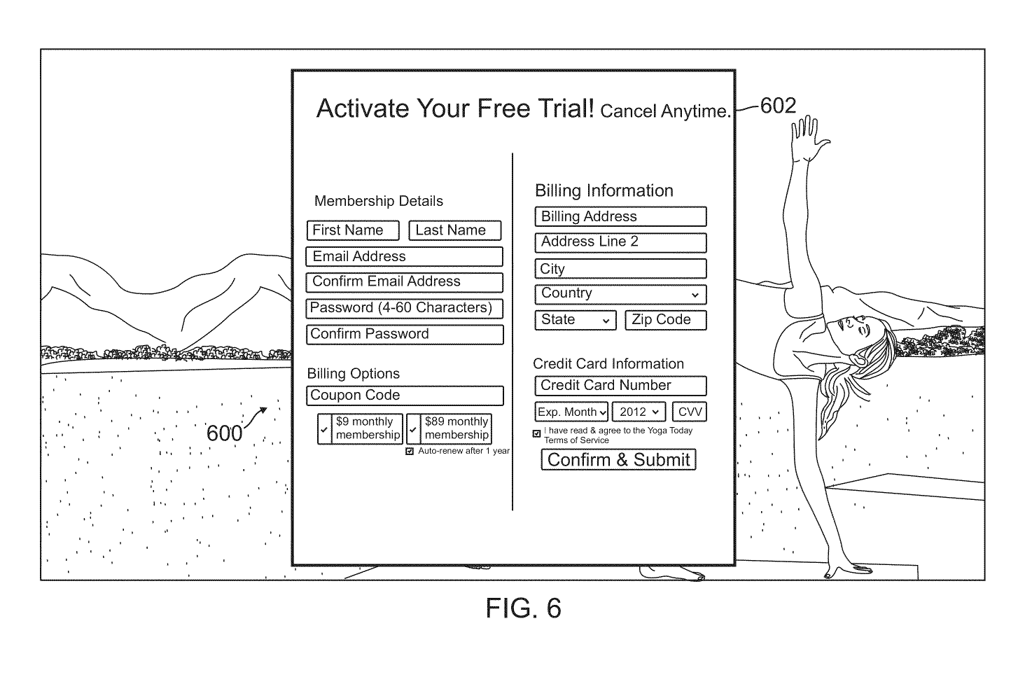

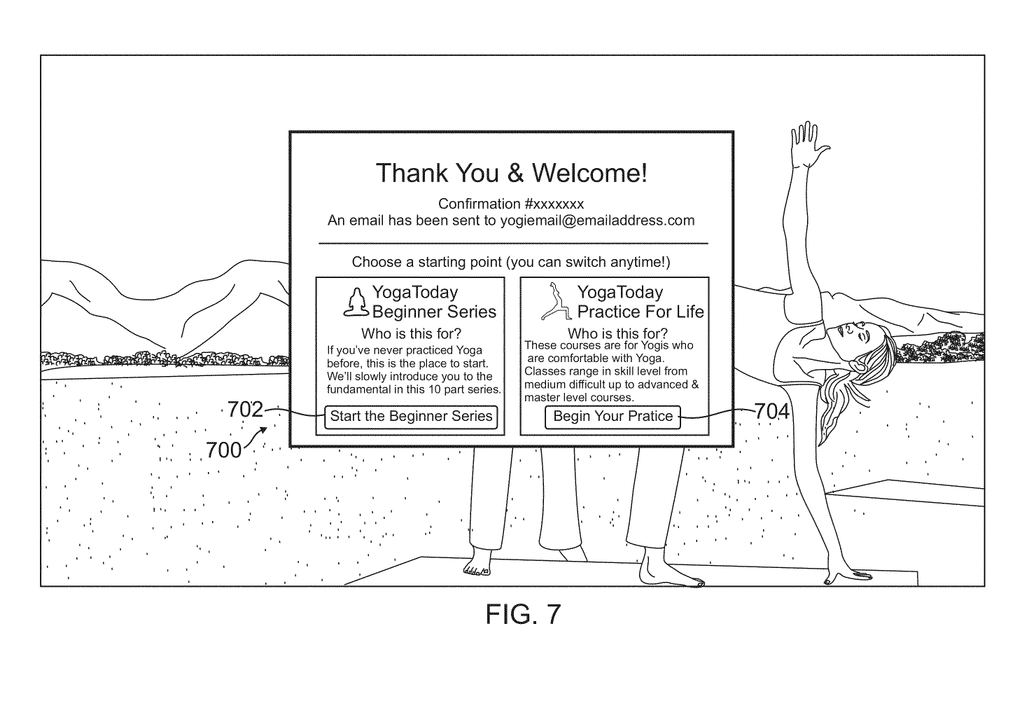

At the login screen 400 of FIG. 4, non-members are given the option to sign up and become a member. If the user selects this option, then the process advances to box B210, where the user is shown a screen 500 similar to that illustrated in FIG. 5. At this screen 500, the user is prompted to sign up. If the user selects the signup button 502, he or she is taken to a signup screen 600, as shown in box B210 and FIG. 6. Once the user submits the required information using the dialog box 602, he or she may be taken to a welcome screen 700, as shown in box B214 and FIG. 7. At the welcome screen 700, the user may have the option to choose between a beginner level of instruction 702 and one or more advanced levels of instruction 704. Regardless of which option the user chooses, however, once a selection is made a video is immediately loaded and playback begins (boxes B216 and B218, FIG. 3).

The video content of the webpage may relate to anything. In the illustrated embodiment, the content is exercise, such as an instructional yoga class. However, the webpage is not limited to any particular content. For example, the content could relate to cooking, photography, needlepoint, or anything else. The content could, for example, be feature films, television shows, kids programming, etc.

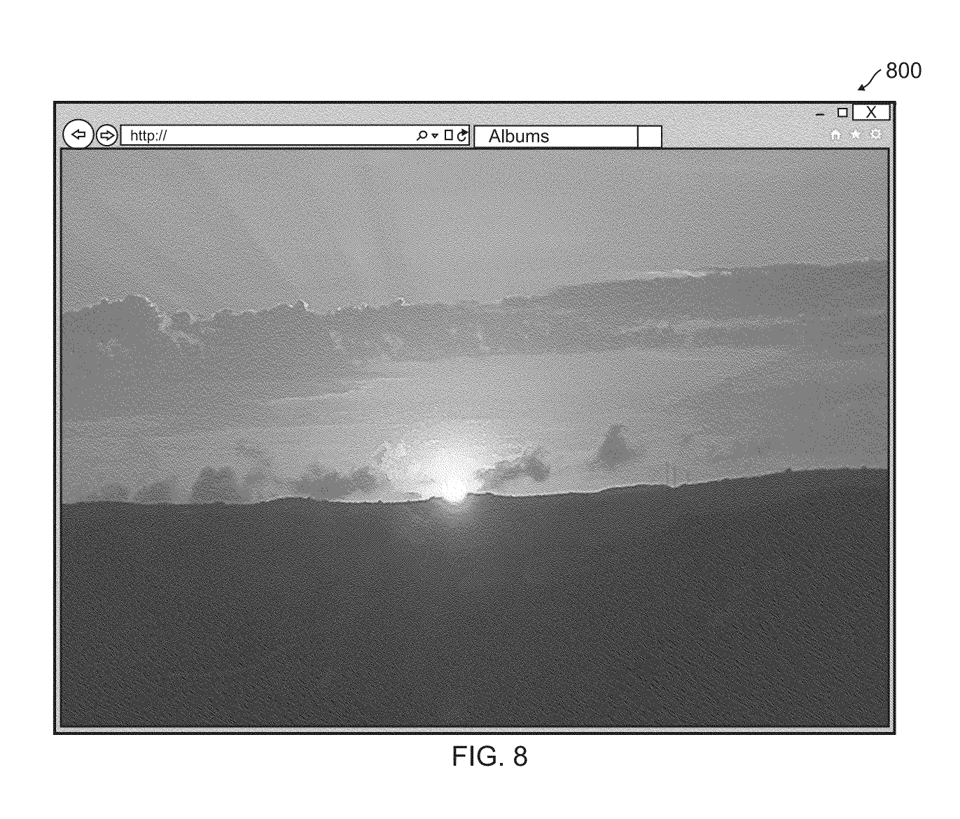

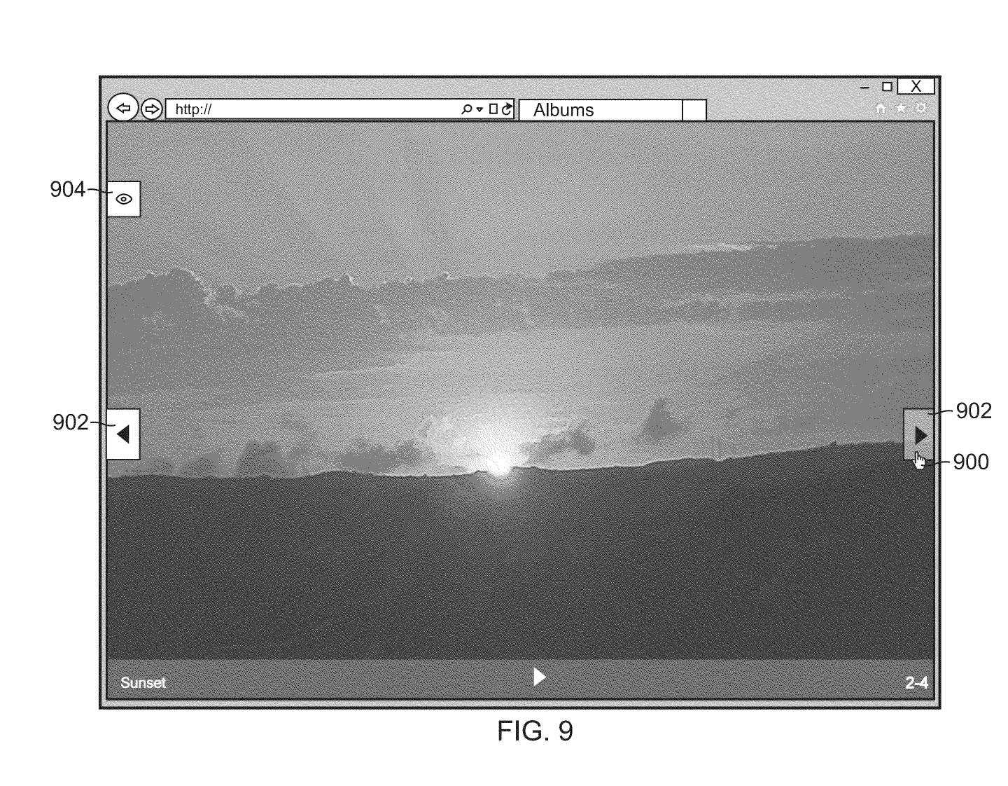

In another embodiment, content of the webpage may be still images, rather than videos. For example, FIGS. 8-10 illustrate screenshots of a webpage 800 offering photographic content. The user navigates to the webpage 800, and if he or she is a logged-in member, full-screen images are immediately shown, as in FIG. 8. Preferably, the images occupy the entirety of the screen. However, if the user makes an input, such as by touching the screen, moving, or clicking his or her mouse, a user interface may appear. For example, in FIG. 9 the user has moved his or her mouse and a pointer 900 and scrolling arrows 902 appear on the screen. The user may use the pointer 900 and the arrows 902 to scroll through each of the photos in the library by clicking the pointer 900 on the arrows 902.

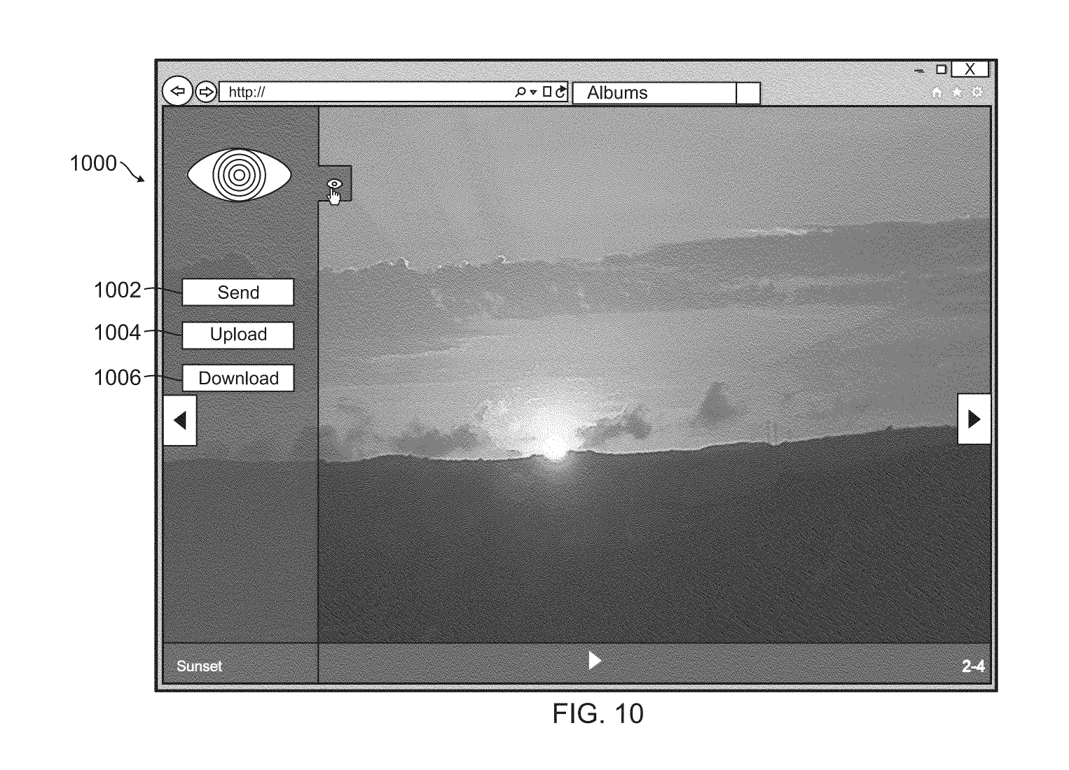

A dropdown menu icon 904 also appears. Selecting the dropdown menu icon 904, such as by clicking on it with the pointer 900, makes a dropdown menu 1000 appear on the graphical user interface (GUI), as shown in FIG. 10. The dropdown menu 1000 may include several commands, such as arrows to adjust a size of the photos (not shown), a “SEND” command 1002 for sending one or more photos to other users, an “UPLOAD” command 1004 for uploading photos to the webpage 800, and a “DOWNLOAD” command 1006 for downloading photos from the webpage 800. For resizing, three example sizes for viewing images may be small, medium and large, but any number of sizes may be provided. The user may also be able to navigate through albums of photographs using the dropdown menu, and/or organize photos into albums, such as by dragging and dropping with a pointing device. The webpage may also include additional functionality, such a timer (not shown), adjustable audio (not shown), etc.

In one embodiment, a user of the site may send one or more photos by selecting the “SEND” button 1002. After doing so and selecting one or more photos to send, the webpage may create a link to a uniform resource locator (URL), and send the link to a recipient user, such as via e-mail. The link is associated with the webpage 800, such as that shown in FIG. 8, so that when the recipient selects the link he or she is taken to the URL and immediately shown full-size images of the photos that the sender selected. For security, the link may be tied to the user's browser, so that only one recipient can view the images at that URL. If multiple links are sent to multiple recipients, each recipient may receive a link to a unique URL, so that no two users view the content on the same webpage.

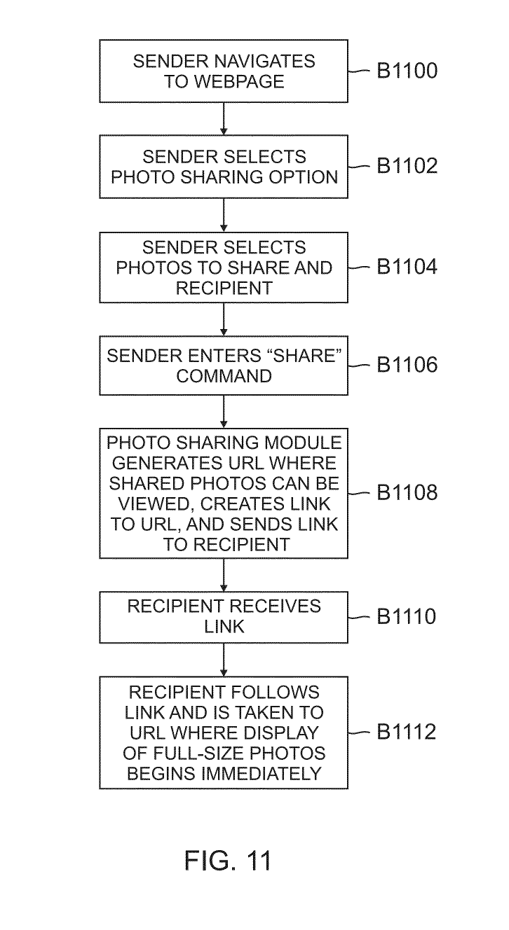

FIG. 11 is a flowchart illustrating one embodiment of a method for displaying content on a webpage. More particularly, the illustrated method describes steps for enabling a first user, a sender, to send photos to a second user, a recipient, such that the recipient need only click a link to immediately begin display of full-size images. The process begins at box B1100, when the sender navigates to an Internet webpage that is configured to store, display and share photos, such as the webpage 800 of FIG. 8. At box B1102, the sender selects a photo sharing option. For example, the sender may select the dropdown menu icon 904, and from there select the “SEND” command 1002. Then, at box B1104, the sender selects the photos he or she wishes to share. For example, the sender may navigate through one or more albums and select individual photos, or select one or more albums at a time. When the sender has selected all desired photos, he or she enters a “SHARE” command (not shown), which may, for example, be contained in the dropdown menu 1000. Then, at box B1108, a photo sharing module (not shown) generates a URL where the recipient can view the shared photos, creates a link to the URL, and sends the link to the recipient. The link may be sent, for example, via e-mail, small message service (SMS, aka text message), or via any other medium. The recipient receives the link at box B1110, and follows the link at box B1112. Upon clicking the link, the recipient is taken to the URL where display of the shared photos immediately begins.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

What is claimed is:

1. A machine-executable method for displaying webpage media content, the method comprising:
a network device receiving an input from a computing system;
the network device verifying whether a user associated with the computing system is a logged-in member; and
if the user is a logged-in member, then immediately beginning display or playback of the media content on a display device or a webpage display application of the computing system, without receiving any further input from the computing system.

2. The method of claim 1, wherein the media content fills a full viewable area of the display device or the webpage display application without any user interface (UI) elements, ads, overlay dialogs, or blank space.

3. The method of claim 1, wherein if the user is not a logged-in member, then beginning playback of a promotional video.

4. The method of claim 3, further comprising displaying a login screen after playback of the promotional video.

5. The method of claim 4, wherein the login screen includes a link that enables the user to become a member.

6. The method of claim 1, wherein the media content comprises a video or at least one still image.

7. The method of claim 1, wherein the network device is a server.

8. The method of claim 1, further comprising receiving an input from an input device of the computing system and displaying at least one of a pointer and a scrolling arrow on the display device.

9. The method of claim 1, further comprising receiving an input from an input device of the computing system and displaying a menu on the display device.

10. The method of claim 9, wherein the menu includes at least one of a send command for sending one or more images to other users, an upload command for uploading images to the network device, and a download command for downloading images from the network device.

11. A system for displaying webpage media content, the system comprising:
a computing system including a display device or a webpage display application; and
a network device;
wherein the network device is configured to receive an input from the computing system, verify whether a user associated with the computing system is a logged-in member, and if the user is a logged-in member, then immediately begin display or playback of the media content on the display device or the webpage display application of the computing system, without receiving any further input from the computing system.

12. The system of claim 11, wherein the media content fills a full viewable area of the display device or the webpage display application without any user interface (UI) elements, ads, overlay dialogs, or blank space.

13. The system of claim 11, wherein if the user is not a logged-in member, then the network device is configured to begin playback of a promotional video.

14. The system of claim 13, wherein the network device is configured to display a login screen after playback of the promotional video.

15. The system of claim 14, wherein the login screen includes a link that enables the user to become a member.

16. The system of claim 11, wherein the media content comprises a video or at least one still image.

17. The system of claim 11, wherein the network device is a server.

18. The system of claim 11, wherein the network device is configured to receive an input from an input device of the computing system and display at least one of a pointer and a scrolling arrow on the display device.

19. The system of claim 11, wherein the network device is configured to receive an input from an input device of the computing system and display a menu on the display device.

20. The system of claim 19, wherein the menu includes at least one of a send command for sending one or more images to other users, an upload command for uploading images to the network device, and a download command for downloading images from the network device.
